(19) United States
(12) Patent Application Publication
(10) Pub. No.: US 2014/0149251 A1
(43) Pub. Date: May 29, 2014

(54) SYSTEMS AND METHODS FOR MATCHING BUYERS AND SELLERS BASED ON BUSINESS ORIENTED PARAMETERS

(71) Applicant: Michael Stockwell, Corona del Mar, CA (US)

(72) Inventor: Michael Stockwell, Corona del Mar, CA (US)

(21) Appl. No.: 14/089,481

(22) Filed: Nov. 25, 2013

Related U.S. Application Data
(60) Provisional application No. 61/729,523, filed on Nov. 23, 2012.

(51) Int. Cl. G06Q 30/06

(52) U.S. Cl. CPC G06Q 30/0613; G06Q 30/0609
USPC 705/26.35; 705/26.41

(57) ABSTRACT

There are provided systems and method for matching buyers and sellers based on business oriented parameters. An exemplary method may include receiving at least one seller attribute for a seller of a business, at least one business attribute for the business, and at least one buyer attribute for each of a plurality of buyers of the business, determining at least one seller parameter from the at least one seller attribute, determining the at least one business parameter from the at least one business attribute, determining at least one buyer parameter from the at least one buyer attribute, and comparing, using one or more hardware processors of a server, the at least one seller parameter and the at least one business parameter to the at least one buyer parameter for the each of the plurality of buyers to obtain a list of matches for the business and the plurality of buyers.

### CROSS REFERENCE TO RELATED APPLICATION

Pursuant to 35 U.S.C. §119(e), this application claims priority to the filing date of U.S. Provisional Patent Application Ser. No. 61/729,523, filed Nov. 23, 2012, which is incorporated by reference in its entirety.

### TECHNICAL FIELD

Example embodiments of the present application relate generally to matching buyers and sellers based on business oriented parameters, and more specifically to standardizing behavioral traits of buyers and sellers of a business with the businesses attributes to find more specific matches, creating purchasing opportunities between matched buyers and sellers, and completing a transaction for the business.

### BACKGROUND

A significant majority of businesses, both small and franchise, end up going unsold as sellers rely on chance when attempting to post “For Sale” listings using web-based approaches. It is estimated that only 15% of small businesses actually sell. A prospective buyer of a business may never see the sale posting or may view sale postings with incorrect descriptors, insufficient information, or information that is not directed to important concerns of the prospective buyers. For example, the prospective buyer may be most concerned with talent and/or skills required when operating the business. However, the seller of the business may direct a posting to location and potential rewards, including expected revenue, when creating the posting for the business. Thus, without knowing where to look and receiving adequate information, the prospective buyer may never investigate a business that may be a good match for the buyer.

When businesses do not sell, the business is stuck with an owner who may not want to own and operate the business. It is estimated that 55% of employees dislike or hate their job. This misalignment of careers can take a large toll both on the business and the owner. The owner may spend minimal time, or “just enough,” to keep the business afloat, or may even choose to shut the business down if there are insufficient time and/or money on hand. These occurrences lead to further unemployment caused by both job mismatches of business owners, and lay off of business employees. While an estimated 68% of Americans would like to “be their own boss” and thus own their own business, simply finding a business is not enough when attributes of the business and interests of the business owner do not align.

### BRIEF DESCRIPTION OF THE DRAWINGS

FIG. 1 is a block diagram of a networked system suitable for implementing the processes described herein, according to an embodiment;

FIG. 2 is an exemplary system displaying a process by a server for transforming buyer, seller, and business parameters to a common set of parameters to determine a score for a match likelihood between the business and the buyer, according to an embodiment;

FIG. 3A is an exemplary display interface for a business listing and sale application, according to an embodiment;

FIG. 3B is an exemplary profile of a seller of a business accessible through a business listing and sale application, according to an embodiment;

FIG. 3C is an exemplary profile of a prospective buyer as displayed to a seller of a business, according to an embodiment;

FIG. 4 is a flowchart of an exemplary process for matching buyers and sellers based on business oriented parameters, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that match buyers and sellers based on business oriented parameters. Systems suitable for practicing methods of the present disclosure are also provided.

A seller of a business may utilize an online website to advertise their business to a set of matching buyers of the business. The seller may access the website through a browser application or dedicated application of the website and create a profile for the business. The profile may be created through seller input corresponding to the seller and the business for sale. For example, the seller may provide information about the seller, such as traits, talents, business values, or other seller attributes. Additionally, the seller may fill out questionnaires and/or tests that may help to determine seller attributes. The seller may also transmit business attributes in a similar fashion to the website, such as through direct input (e.g. data corresponding to the business, type/industry of the business, location of the business, etc.) or through additional fact finding tests. Once the seller and business attributes have been received by the website, the website may transform the attributes to a set of seller parameters and business parameters. These parameters may then be utilized by the seller with additional information about the business (e.g. purchase price, descriptions, media, etc.) to create a “For Sale” business listing on the website.

A prospective buyer of a business may access the website. Instead of simply browsing business listings or performing rudimentary searches, the buyer may provide buyer attributes. Similar to the seller, the buyer attributes may be received from direct buyer input or may be determined using one or more questionnaires/tests that help determine the buyers attributes as they relate to purchasing and running a business. These attributes may correspond to expected business rewards, location, type/industry, expected work time, talents, or other attributes of a potential business owner. Once the buyer has transmitted buyer attributes to the website, the website may transform the attributes to a set of parameters corresponding to the buyer. These determined buyer parameters may then be compared to the seller and business parameters to determine whether the prospective buyer would be a good match/fit for the business.

A score based on a likelihood of a match between the buyer and the business may then be determined. The score can be displayed to the buyer and the seller. The buyer then has the opportunity to view businesses that would be a good match for the buyer. Additionally, the seller may view a list of prospective buyers that would be likely to purchase and satisfactorily run the business. The website may facilitate contact between the buyer and the seller, including potential sale agreements. If the buyer would like to first experience the business before a full purchase, the website may further establish a down payment and apprenticeship period before the buyer fully commits to purchasing the business. Thus, the website creates an enhanced likelihood of transactions between business sellers and prospective buyers.

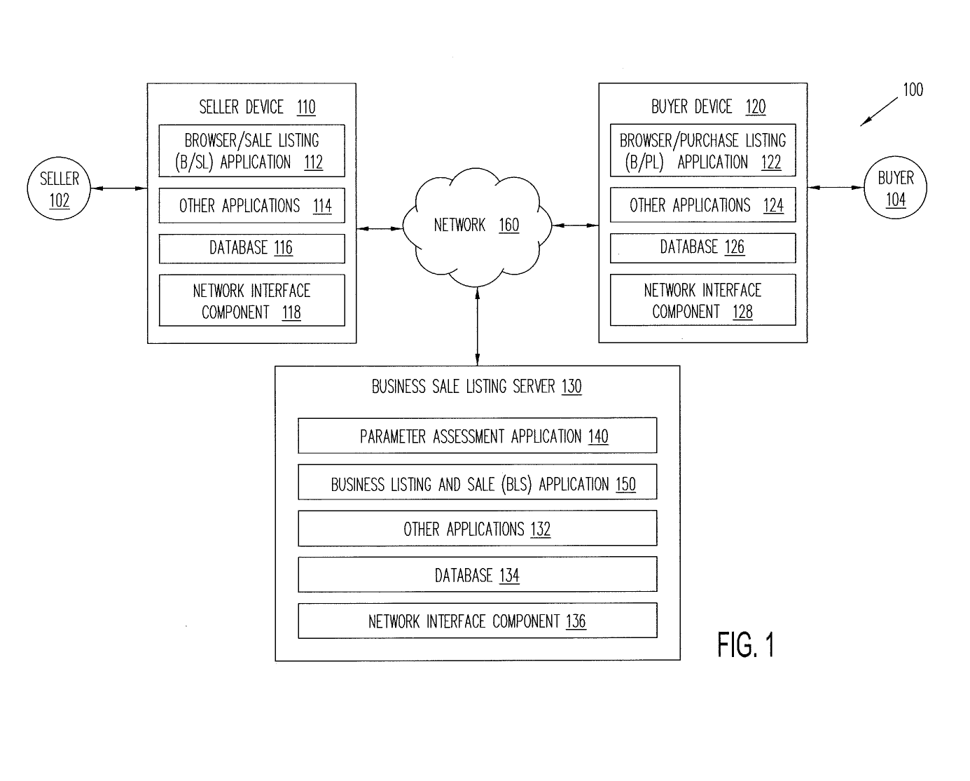

FIG. 1 is a block diagram of a networked system 100 suitable for implementing the processes described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a seller 102, a buyer 104, a seller device 110, a buyer device 120, and a business sale listing server 130 in communication over a network 160. Seller 102, such as a seller of a business and/or business opportunity (as will be discussed in more detail herein), may utilize seller device 110 to engage in a transaction for sale of a business with buyer 104 through buyer device 120. Seller 102 and buyer 104 may utilize business sale listing server 130 to complete the transaction between the two parties.

Seller device 110, buyer device 120, and business sale listing server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Seller device 110 may be implemented using any appropriate hardware and software configured for wired and/or wireless communication with buyer device 120 and/or business sale listing server 130 over network 160. For example, in one embodiment, seller device 110 may be implemented as a personal computer (PC), a smart phone, personal digital assistant (PDA), laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

Seller device 110 of FIG. 1 contains a browser/sale listing (B/SL) application 112, other applications 114, a database 116, and a network interface component 118. B/SL application 112 and other applications 114 may correspond to processes, procedures, and/or applications executable by a hardware processor, for example, a software program. In other embodiments, seller device 110 may include additional or different software as required.

B/SL application 112 may be used, for example, to provide a convenient interface to permit seller 102 to provide seller and business attributes, list a business for sale, and engage in a transaction for the business with buyer 104. For example, B/SL application 112 may be implemented as an application having a user interface enabling seller 102 to provide seller input and/or complete attribute tests corresponding to seller 102 and/or a business of seller 102. B/SL application 112 may further enable seller 102 to create a “For Sale” posting/advertisement for the business and view matching prospective buyers, such as buyer 104, who have an increased likelihood of purchasing the business. B/SL application 112 may further enable seller 102 to create a contract for sale of the business and enter into a transaction for the sale of the business. In certain embodiments, B/SL application 112 may correspond more generally to a web browser configured to view information available over the Internet or access a website corresponding to business sale listing server 130.

Seller 102 may initially utilize B/SL application 112 to access business sale listing application 130. Seller 102 may then provide input to B/SL application 112 for transmission to business sale listing server 130. Input provided by seller 102 may include input corresponding to either or both of seller 102 and a business owned and/or operated by seller 102 that seller 102 wishes to sell. The input from seller 102 may thus correspond to seller attributes and/or business attributes. Seller attributes may correspond to personal skills, personal talents, attributes corresponding to owning/operating the business, personal communication style, personal behavioral style, personal values corresponding to the business, personal business motivators, expected/earned rewards associated with the business, current personal location, personal experience in an industry of the business, personal experience with the business. In addition, business attributes may correspond to an industry of the business, a type of the business, location of the business, required business licensing, required personal licensing for operation of the business, and required personal experience in the industry of the business

Attributes may come in the form of direct user input, such as completing a form describing seller 102 and/or the business, uploading information possessed by seller 102 (e.g. data sheets, appraisals, etc.), or describing/characterizing seller 102 and/or the business. Additionally, the attributes may be extracted by business sale listing server 130 through questionnaires/tests completed by seller 102, as will be explain in more detail herein. For example, B/SL application 112 may present an attribute assessment test to seller 102 for completion by seller 102. The test may correspond to one or both of seller 102 and the business for sale by seller 102. Once seller input and/or attribute assessment tests have be transmitted by B/SL application 112 to business sale listing server 130, seller parameters and business parameters may be determined by business sale listing server 130, as will be explained in more detail herein.

B/SL application 112 may further allow seller 102 to complete a “For Sale” advertisement, posting, or listing for the business with business sale listing server 130. Completion of the business sale listing may be done by seller 102 with additional information provided by seller 102, such as images, videos, purchase terms, criteria/information about the business, or other sale information for the business. In various embodiments, the business sale listing may also be generated for approval by seller 102 partially or completely using seller attributes and business attributes provided by seller 102.

Once a business sale listing for the business is created by seller 102 with business sale listing server 130, matches to prospective buyers may be determined by business sale listing server 130 as will be discussed in more detail herein. B/SL application 112 may display the results of this matching process. B/SL application 112 may display a list of potential buyers matching the attributes. In various embodiments, scores based on a match likelihood may be displayed next to prospective buyers in the list. The scores may increase when there is a higher correlation between parameters of the seller, the business, and the buyer. Thus, seller 102 may view prospective buyers in B/SL application 112 by the match likelihood of the buyers to the business.

B/SL application 112 may also assist seller 102 in viewing profiles of the prospective buyers and completing a transaction with one of the prospective buyers, such as buyer 104. Seller 102 may select one or more prospective buyer in a list provided in B/SL application 112. Seller 102 may view each of the prospective buyer's profile. Additionally, B/SL application 112 may enable seller 102 to interact with each of the prospective buyers. For example, seller 102 may be able to transmit offers to, correspond with, provide additional information to, or answer questions from each of the prospective buyers.

If seller 102 and a prospective buyer, such as buyer 104, wish to engage in a transaction for the business, B/SL application 112 may transmit and receive offers and counteroffers for the business. B/SL application 112 may also interact with business sale listing server 130 to complete the transaction when there is an agreement to the transaction. The transaction may include terms of sale, price, and an apprenticeship term if required, as will be explained in more detail herein.

Seller device 110 includes other applications 114 as may be desired in particular embodiments to provide features to seller device 110. For example, other applications 114 may include security applications for implementing client-side security features, programmatic client applications for interfacing with appropriate application programming interfaces (APIs) over network 160, or other types of applications. Other applications 114 may also include email, texting, voice, IM, and/or social networking applications that allow a user to send and receive emails, calls, texts, messages, postings, and other notifications through network 160. In various embodiments, other applications 114 may include financial applications, such as banking, online payments, money transfer, or other applications associated with a financial institution. Additionally, other application may include browser applications when not provided by B/SL application 112. Other applications 114 may contain other software programs, executable by a processor, including a graphical user interface (GUI) configured to provide an interface to the user.

Seller device 110 may further include database 116 which may include, for example, identifiers such as operating system registry entries, cookies associated with B/SL application 112 and/or other applications 114, identifiers associated with hardware of seller device 110, or other appropriate identifiers, such as identifiers used for payment/user/device authentication or identification. In one embodiment, identifiers in database 116 may be used by business sale listing server 130, to associate seller device 110 with a particular account maintained by business sale listing server 130.

Database 116 may include information for seller 102 and/or a business for sale by seller 102. Information for seller 102 may correspond to personal information and/or attribute assessment test information. Information for the business may correspond to business data, such as accounting information, statistical information, or other business related information. Information in database 116 may be uploaded to business sale listing server 130 by B/SL application 112 for use in determining seller parameters of seller 102 and business parameters.

In various embodiments, seller device 110 includes at least one network interface component 118 adapted to communicate with buyer device 120 and business sale listing server 130 over network 160. Network interface component 118 may include a DSL (e.g., Digital Subscriber Line) modem, a PSTN (Public Switched Telephone Network) modern, an Ethernet device, a broadband device, a satellite device and/or various other types of wired and/or wireless network communication devices. In various embodiments, network interface component 118 may include a communication module for short range communications including microwave, radio frequency, infrared, Bluetooth, and near field communication devices.

Buyer 104, such as a prospective buyer of a business and/or business opportunity for sale by seller 102 (as will be discussed in more detail herein), may utilize buyer device 120 to find a business matching buyer 104's attributes/parameters. Buyer device 120 may thus correspond generally to a similar device, including similar functions, to seller device 110. Buyer device 120 may be implemented using any appropriate hardware and software configured for wired and/or wireless communication with seller device 110 and/or business sale listing server 130 over network 160. For example, in one embodiment, buyer device 120 may be implemented as a personal computer (PC), a smart phone, personal digital assistant (PDA), laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

Buyer device 120 of FIG. 1 contains a browser/purchase listing (B/PL) application 122, other applications 124, a database 126, and a network interface component 128. B/PL application 122 and other applications 124 may correspond to processes, procedures, and/or applications executable by a hardware processor, for example, a software program. In other embodiments, buyer device 120 may include additional or different software as required.

B/PL application 122 may be used, for example, to provide a convenient interface to permit buyer 104 to provide buyer attributes, find a business for sale, and engage in a transaction for the business with seller 102. For example, B/PL application 122 may be implemented as an application having a user interface enabling buyer 104 to provide buyer input and/or complete attribute tests corresponding to buyer 104. B/PL application 122 may further enable buyer 104 view matching prospective businesses for sale by business sellers, such as seller 102, where the business is of increased relevance to attributes/parameters of buyer 104. B/PL application 122 may further enable buyer 104 to enter into a contract for sale of the business and complete the transaction. In certain embodiments, B/PL application 122 may correspond more generally to a web browser configured to view information available over the Internet or access a website corresponding to business sale listing server 130.

Buyer 104 may initially utilize B/PL application 122 to access business sale listing server 130. Buyer 104 may then provide input to B/PL application 122 for transmission to business sale listing server 130. Input provided by buyer 102 may include input corresponding to buyer 104, such as buyer attributes. Buyer attributes may correspond to personal skills, personal talents, attributes desired in a business, personal communication style, personal behavioral style, personal values corresponding to the business, personal business motivators, desired rewards associated with the business, current personal location, personal experience in an industry of the business, personal experience with the business or another business, and current licensing/training of the buyer. In addition, buyer attributes may also correspond desirable traits of a business, including an industry of the business, a type of the business, location of the business, required business licensing, required personal licensing for operation of the business, and required personal experience in the industry of the business

Attributes may come in the form of direct user input, such as completing a form describing buyer 104, uploading information possessed by buyer 104 (e.g. attribute assessment test results, resumes, prior experience, etc.), or describing/characterizing buyer 104. Additionally, the attributes may further be extracted by business sale listing server 130 through questionnaires/tests completed by buyer 104, as will be explain in more detail herein. For example, B/PL application 122 may present an attribute assessment test to buyer 104 for completion by buyer 104. Once buyer input and/or attribute assessment tests have been transmitted by B/PL application 122 to business sale listing server 130, buyer parameters may be determined by business sale listing server 130, as will be explained in more detail herein.

B/PL application 122 may further allow buyer 104 to browse potential business matches. Matches between buyer 104 and prospective business may be determined by business sale listing server 130. B/PL application 122 may display the results of this matching process. B/PL application 122 may display a list of potential businesses matching the attributes of buyer 104. In various embodiments, scores based on a match likelihood may be displayed next to prospective buyers in the list. The scores may increase when there is a higher correlation between parameters of the seller, the business, and the buyer. Thus, buyer 104 may view prospective businesses in B/PL application 122 by the match likelihood of the buyers to the business.

B/PL application 122 may also assist buyer 104 in viewing profiles of the prospective businesses and completing a transaction with a seller of one of the businesses for sale, such as seller 102. Buyer 104 may select one or more prospective businesses in a list provided in B/PL application 122. Buyer 104 may view each of the prospective businesses profile. Additionally, B/PL application 122 may enable buyer 104 to interact with each of the business sellers. For example, buyer 104 may be able to transmit offers to, correspond with, provide additional information to, or answer questions from each of the business sellers.

If buyer 104 and a business seller, such as seller 102, wish to engage in a transaction for the business, B/PL application 122 may transmit and receive offers and counteroffers for the business. B/PL application 122 may also interact with business sale listing server 130 to complete the transaction when there is an agreement to the transaction. The transaction may include terms of sale, price, and an apprenticeship term if required, as will be explained in more detail herein.

Buyer device 120 includes other applications 124 as may be desired in particular embodiments to provide features to buyer device 120. For example, other applications 1.24 may include security applications for implementing client-side security features, programmatic client applications for interfacing with appropriate application programming interfaces (APIs) over network 160, or other types of applications. Other applications 124 may also include email, texting, voice, IM, and/or social networking applications that allow a user to send and receive emails, calls, texts, messages, postings, and other notifications through network 160. In various embodiments, other applications 124 may include financial applications, such as banking, online payments, money transfer, or other applications associated with a financial institution. Additionally, other application may include browser applications when not provided by B/PL application 122. Other applications 124 may contain other software programs, executable by a processor, including a graphical user interface (GUI) configured to provide an interface to the user.

Buyer device 120 may further include database 126 which may include, for example, identifiers such as operating system registry entries, cookies associated with B/PL application 122 and/or other applications 124, identifiers associated with hardware of buyer device 120, or other appropriate identifiers, such as identifiers used for payment/user/device authentication or identification. In one embodiment, identifiers in database 126 may be used by business sale listing server 130, to associate buyer device 120 with a particular account maintained by business sale listing server 130.

Database 126 may include information for buyer 104. Information for buyer 104 may correspond to personal information and/or attribute assessment test information. Information in database 126 may be uploaded to business sale listing server 130 by B/PL application 122 for use in determining buyer parameters of buyer 104.

In various embodiments, buyer device 120 includes at least one network interface component 128 adapted to communicate with seller device 110 and business sale listing server 130 over network 160. Network interface component 128 may include a DSL (e.g., Digital Subscriber Line) modem, a PSTN (Public Switched Telephone Network) modem, an Ethernet device, a broadband device, a satellite device and/or various other types of wired and/or wireless network communication devices. In various embodiments, network interface component 128 may include a communication module for short range communications including microwave, radio frequency, infrared, Bluetooth, and near field communication devices.

Business sale listing server 130 may be maintained, for example, by an online service provider, which may provide services for purchase and sale of businesses on behalf of seller 102 and to buyer 104. In this regard, business sale listing server 130 includes one or more processing applications, which may provide determination of buyer, seller, and business parameters, comparison of parameters of the buyer, seller, and business, and transaction assistance between the seller and the buyer.

Business sale listing server 130 of FIG. 1 includes a parameter assessment application 140, a business listing and sale (BLS) application 150, other applications 132, a database 134, and a network interface component 136. Parameter assessment application 140, BLS application 150, and other applications 132 may correspond to processes, procedures, and/or applications executable by a hardware processor, for example, a software program. In other embodiments, business sale listing server 130 may include additional or different software as required.

Business sale listing server 130 includes parameter assessment application 140, which may be configured to receive attributes corresponding to each of a seller, a seller's business, and a buyer, and transform the attributes to seller parameters, business parameters, and buyer parameters. As previously discussed, parameter assessment application 140 may receive seller attributes and business attributes from seller 102 through seller input and seller attribute assessment tests. Attributes of a seller and/or business may correspond to identification by seller 102 of required and/or desired skills of an owner-operator of seller 102's particular business. Seller 102 and the business of seller 102 may determine the skills.

Seller 102 may also benchmark current required range of skills or competencies deemed desirable to operate, manage and lead seller 102's business. For example, this input may derive from the TTI TriMetrix HD Job benchmarking instrument (a behavioral assessment test) or other attribute assessment test, in part or in whole. Seller 102 may provide communication and/or behavioral style attributes required for the business, as defined by a specific attribute assessment test. In one embodiment, this attribute input derives from the TTI DISC Profile assessment instrument. In another, similar scores are derived from a portion of the TTI TriMetrix HD assessment instrument. In yet another, attribute input corresponding to a franchise/franchisor may be derived from “IF THE FRANCHISE COULD TALK” ® attribute assessment test. Where the attribute input is completed for a franchise/franchisor, the franchisor may not necessarily complete the attribute assessment test. Instead, an agent or hired contractor (e.g. a subject matter expert) may complete the test.

Seller 102 may also provide seller and/or business attributes directed to values, motivators, and talent of the business, as determined by an attribute assessment test. In one embodiment, this input derives from the TTI PIAV assessment instrument. In another, similar scores are derived from a portion of the TTI TriMetrix assessment instrument. In yet another, attribute input corresponding to a franchise/franchisor may be derived from “IF THE FRANCHISE COULD TALK”® attribute assessment test. Where the attribute input is completed for a franchise/franchisor, the franchisor may not necessarily complete the attribute assessment test. Instead, an agent or hired contractor (e.g. a subject matter expert) may complete the test.

Seller 102 may provide attributes directed to seller 102's business as well. For example, seller 102 may provide attribute information about the businesses industry type. Such information may come from The North American Industry Classification System (NAICS), a standard used by Federal statistical agencies in classifying business establishments for the purpose of collecting, analyzing, and publishing statistical data related to the U.S. business economy. Seller 102 may provide a location of business and location of a prospective buyer, required licensing, required/desired industry or business type experience, and other preferred attributes, as expressed by seller 102.

Additionally, parameter assessment application 140 may receive buyer attributes from buyer 104 through buyer input and buyer attribute assessment tests. Buyer attributes may correspond to identification by buyer 104 of prospective buyer communication and/or behavioral style, as defined by a specific attribute assessment test. In one embodiment, this input derives from the TTI DISC Profile assessment instrument. In another, similar scores are derived from a portion of the TTI TriMetrix HD assessment instrument. Buyer 104 may provide values, motivators, and talent attributes, as defined by a specific attribute assessment test. In one embodiment, this input derives from the TTI PIAV assessment instrument. In another, similar scores are derived from a portion of the TTI TriMetrix HD assessment instrument. Buyer 104 may provide other attributes of buyer 104, such as licensing attributes, experience attributes, apprenticeship attributes, funding attributes, and other buyer attributes. Additionally, buyer 104 may provide information desirable in a business, such as desired business type/industry, business location, and other preferred attributes as expressed by buyer 104.

Parameter assessment application 140 may process the received seller attributes, business attributes, and buyer attributes to determine seller parameters, business parameters, and buyer parameters, respectively. User input and results from attribute assessment tests may correspond to a wide variety of attributes. For example, buyer and seller attributes may be one or more of personal skills, personal talents, attributes of the business, personal communication style, personal behavioral style, personal values corresponding to the business, personal business motivators, desired business rewards, desired business location, current personal location, personal experience in an industry of the business, and desired business industry. Additionally, business attributes may be one or more of the industry of the business, a type of the business, location of the business, required business licensing, required personal licensing for operation of the business, and required personal experience in the industry of the business.

Thus, due to the variety of potential attributes, parameter assessment application 140 may transform the seller attributes, the business attributes, and the buyer attributes to seller parameters, business parameters, and buyer parameters, respectively. These parameters may correspond to a common set of parameters for each of the seller, the business, and the buyer. For example, the seller parameters may be transformed into a set of “common” or previously known, scored, and stored, seller parameters with business sale listing server 130. Similarly, the business parameters and the buyer parameters may correspond to common parameters already known, scored, and stored with business sale listing server 130.

By transforming the attributes for each of the seller, the business, and the buyer to the seller parameters, business parameters, and buyer parameters, parameter assessment application 140 may standardize a “common” language describing the seller, the business, and the buyer. This common language may correspond to a set of categories defining the parameters. For example, attributes that define a “reliable” buyer or seller, or a “dominant” buyer or seller may be placed in these parameter categories. Thus, a buyer or seller exhibiting these attributes may be defined under these more standardized parameters.

Once parameter assessment application 140 has transformed attributes to a common set of seller parameters, business parameters, and buyer parameters, parameter assessment application 140 may then compare the seller parameters, the business parameters, and the buyer parameters to determine a list of matches between the sellers/seller businesses and the buyers. Thus, parameter assessment application 140 may include a list matching seller 102 and buyer 104. Parameter assessment application 140 may perform the comparison between the seller/seller business and the buyer not just relying on business parameters (e.g. location, industry type, experience) but also based on the parameters and/or desired parameters of seller 102. When matching between seller 102, the business of seller 102, and buyer 104, a higher likelihood of compatibility during work and sale of the business occurs. For example, attributes, such as “reliable” and “friendly with customers” may be important to seller 102. Thus, if buyer 104 possess these parameters corresponding to attributes, there is an increased likelihood of buyer 104 purchasing the business, working with seller 102, and enjoying the business in the long run.

The process by parameter assessment application 140 to match a business to a prospective buyer may include a process of matching the common parameters of the seller, the business, and the buyer. Additionally, seller 102 and buyer 104 may assign and adjust variables of the parameters. Table 1 below displays an exemplary process flowchart for a comparison of parameters, where the parameters may correspond to industry, location, competencies, values of buyer to rewards of the job, behavior fit to the job (the business), behavioral fit to the seller, and values of the buyer to the seller.

TABLE 1

| | | | Next Step | |
|---|---|---|---|---|
| | | | if positive | Next |
| Step | | | or no | Step if |
| Number | Process | Result, if any | criteria | negative |
| 1 | Sort data to individual Seller or | | 2 | |
| | Buyer data set | | | |
| 2 | Ensure alignment of data by | | 3 | |
| | components | | | |
| 3 | USER adjusts component variables, | Aspects of process are | 4 | |
| | if desired | amplified or muted | | |
| | (Nominal setting unmodified is “1”) | based on adjustment of | | |
| | | each variable | | |
| 4 | Sort, Compare and Score for | Match or No entry | 5 | 1 |
| | Industry | Fail | | |
| 5 | Sort, Compare and Score for | Match or No entry | 6 | 1 |
| | Location; business actual to buyer | Fail | | |
| | desired | | | |
| 6 | Sort, Compare and Score for | Algorithm compares, | 7 | |
| | COMPETENCIES fit Buyer 4b to | assigns, and records | | |
| | Job 4c | score | | |
| 7 | Sort, Compare and Score for | Algorithm compares, | 8 | |
| | VALUES fit for Buyer to Rewards | assigns, and records | | |
| | from Job 4c | score | | |
| 8 | Sort, Compare and Score for | Algorithm compares, | 9 | |
| | BEHAVIORAL style fit Buyer 4b | assigns, and records | | |
| | to Job 4c | score | | |
| 9 | Sort, Compare and Score for | Algorithm compares, | 10 | |
| | BEHAVIORAL style fit Buyer 4b | assigns, and records | | |
| | to Seller 4a | score | | |
| 10 | Sort, Compare and Score for | Algorithm compares, | 11 | |
| | VALUES fit Buyer 4b to Seller 4a | assigns, and records | | |
| | | score | | |
| 11 | Interim Scores 42 are multiplied by | Algorithm compares, | 12 | |
| | associated USER Adjusted | assigns, and records | | |
| | Variables 44 (#3 above) and | score FINAL score 46 | | |
| | recorded as Final Component Score | | | |
| | 46 | | | |
| 12 | Total Score 48 is computed by | Cardinal scores are | 13 | |
| | adding all Final Component Scores | sorted and assigned | | |
| | 46 together | ordinal position based on | | |
| | | highest to lowest score | | |
| 13 | Total Score 48 is compared against | Within parameters | 14 | 1 |
| | desired USER Established | Outside parameters/Fail | | |
| | Parameters 24 for Total Score | | | |
| 14 | Results of comparison of Total | END | | |
| | Score 48 to USER Established | | | |
| | Parameters 24 reported and | | | |
| | recorded to system for subsequent | | | |
| | use | | | |

In the above table, the process requires that a value be determined for a particular relationship. For example, buyer 104 may have a behavior score of a particular parameter (e.g. parameter category, such as “dominant” or “aggressive salesman”) from input of buyer 104 and/or an attribute assessment test taken by buyer 104. Seller 102 may possess a behavior score as well. The behavior score may correspond to the same or a different parameter. Parameter assessment application 140 may compare the parameters and determine an interim score for the combination. Each interim score for each comparison may be tallied and used to calculate an end total score, which may further factor in other elements, weights, or changes based on the process and/or user variable selection.

Once a total score is calculated by parameter assessment application 140, the score may be used to determine if seller 102 and buyer 104 are likely to engage in a transaction or be satisfied with the transaction. Threshold scores may determine whether a match between seller 102 (and the business of seller 102) and buyer 104 is reported to a list showing matching businesses and buyers. However, in other embodiments, all matching scores may be reported and seller 102 and/or buyer 104 may filter and browse as desired.

In addition to matching a seller and the sellers business to a buyer, business sale listing server 130 may further provide services to advertise, list, or post “For Sale” information for the business of the seller. Business listing and sale (BLS) application 150 may be configured to provide business sale advertisements, lists, and/or post services to seller 102. BLS application 150 may be configured to create a business sale listing for the business of seller 102 through input of seller 102, such as seller and business attributes, and/or determined parameters of seller 102 and the business of seller 102, such as results of attribute assessment tests and results of the parameter determination of parameter assessment application 140. Additionally, seller 102 may access business sale listing server 130 to provide additional information corresponding to the sale of the business, such as price, terms of sale, media about the business, etc., and create the business sale listing. BLS application 150 may provide templates and may complete part, or all, of the business sale listing. Seller 102 may complete and/or approve the business sale listing. BLS application 150 may be further configured to enable seller 102 to view their business sale listing, edit, change, or delete their business sale listing, and view prospective buyers of the business sale listing, such as buyer 104.

Additionally, BLS application 150 may be configured to create a profile for buyer 104. Buyer input previously presented to parameter assessment application 140 may be utilized in creating the profile. Again, buyer 104 may transmit further information for the profile to BLS application, may complete and/or approve the profile, and may perform editing, changing, and deletion of the profile.

Both seller 102 and buyer 104 may access profile pages to view matches between the business of seller 102 and prospective buyers using BLS application 150. If buyer 104 appears as a prospective buyer, the score of the match likelihood may be displayed. Seller 102 and buyer 104 may utilize the score and the information provided by the other party to deter nine if they would like to research, correspond, negotiate, and possible pursue a transaction for the business of seller 102.

If seller 102 and buyer 104 agree to correspond concerning a transaction for the business of seller 102, BLS application 150 may assist in facilitating the transaction. BLS application 150 may create or receive terms of any proposed transaction. Such terms may be included in a purchase agreement drafted by one or more of seller 102, buyer 104, and/or a representative of business sale listing server 130. Professionals trained in creating and brokering the transaction may be involved, and may be provided by an administrator of business sale listing server 130, in various embodiments. BLS application 150 (or a representative of business sale listing server 130) may also serve as an escrow service to enforce the purchase agreement between seller 102 and buyer 104. BLS application 150 may also monitor the transaction, track funds, monitor the process, and provide updates to seller 102 and buyer 104. In various embodiments, buyer 104 may wish to take an “apprenticeship” with the business of seller 102 prior to purchase. An apprenticeship agreement may be incorporated in the purchase agreement and the status of the apprenticeship may be monitored and/or transmitted to BLS application 150.

In various embodiments, business sale listing server 130 includes other applications 132 as may be desired in particular embodiments to provide features to business sale listing server 130. For example, other applications 132 may include security applications for implementing server-side security features, programmatic server applications for interfacing with appropriate application programming interfaces (APIs) over network 160, or other types of applications. Other applications 132 may contain software programs, executable by a processor, including a graphical user interface (GUI), configured to provide an interface to a user.

Additionally, business sale listing server 130 includes database 134. As previously discussed, seller 102 and/or buyer 104 may establish one or more user accounts with business sale listing server 130. User accounts in database 134 may include user information, such as name, address, birthdate, payment/funding information, additional user financial information, and/or other desired user data. Seller 102 and/or buyer 104 may link user accounts to seller device 110 and/or buyer device 120, respectively, through a user device identifier. Thus, when a device identifier corresponding is transmitted to business sale listing server 130, a corresponding user account may be found. In other embodiments, seller 102 and/or buyer 104 may not have previously established a user account and may utilize an account management application of business sale listing server 130 to create one.

Database 134 may further contain previously parameters used, such as the standardized common set of parameters. Thus, information in database 134 may be utilized by parameter assessment application 140 to determine seller parameters, business parameters, and buyer parameters. In various embodiments, the parameters may be established by an administrator of business sale listing server 130. In other embodiments, the parameters may be transmitted to database 134, for example, from one or more of seller 102, buyer 104, and an attribute assessment testing entity.

In various embodiments, business sale listing server 130 includes at least one network interface component 136 adapted to communicate with network 160 including seller device 110 and/or buyer device 120. In various embodiments, network interface component 136 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

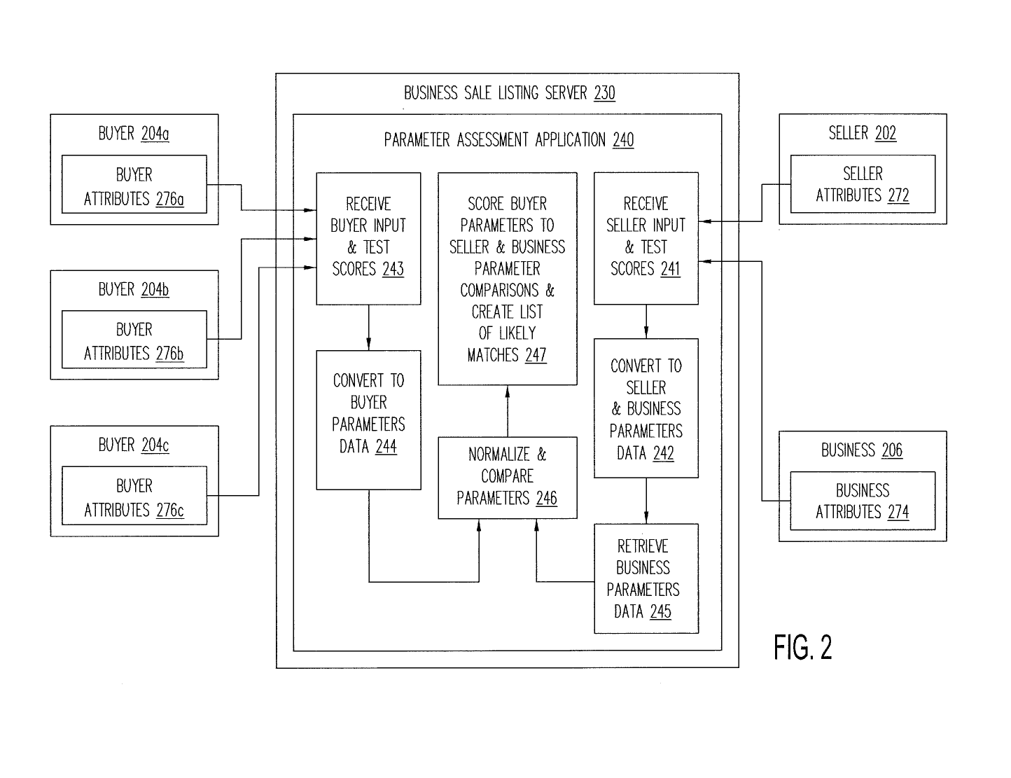

FIG. 2 is an exemplary system displaying a process by a server for transforming buyer, seller, and business parameters to a common set of parameters to determine a score for a match likelihood between the business and the buyer, according to an embodiment. FIG. 2 includes seller 202, which may correspond generally to seller 102 of FIG. 1, and three buyers 204a, 204b, and 204c, each of which may correspond generally to buyer 104 of FIG. 1. Additionally, FIG. 2 includes business sale listing server 230 and parameter assessment application 240, which may correspond generally to business sale listing server 130 and parameter assessment application 140, respectively, of FIG. 1.

Seller 202 may correspond to sellers of small or single business or may correspond to a variety of other business sellers. For example a seller of a business may correspond to a franchisor who wishes to sell a franchise and/or franchise rights (e.g. rights to establish a franchise branch, including number of stores and/or location restrictions of the franchise branch). The seller may also correspond to a partner in a partnership, including businesses, law firms, accounting firms, etc., that may wish to seller the partnership or the partner's specific partner share. The seller may also correspond to an owner of a profit or nonprofit company. Other exemplary sellers and businesses may correspond to hospitals or other care facilities, charities, and/or private contracting opportunities. The aforementioned list is not exhaustive and both the seller and/or business may correspond to another type of seller offering a business opportunity for purchase.

Seller 202 includes seller attributes 272. As previously discussed, seller attributes 272 may correspond to a set of characteristics, factors, or traits of seller 202, which may be either possessed by seller 202 of deemed of importance to seller 202 while owning/operating a business of seller 202. While it is discussed in the embodiment of FIG. 2 that seller 202 providers seller attributes 272, in various embodiments, the franchisor may not necessarily provide attributes 272 corresponding to seller 202. Instead, an agent or hired contractor (e.g. a subject matter expert) may provide attributes 272 that assist in describing seller 202. Additionally, business 206 may correspond to the business of seller 202, where business 206 possesses business attributes 274. Similarly, business attributes 274 may correspond to information characterizing business 206. For example, business attributes 274 may include business location, business industry/type, etc.

Business sale listing server 230 executing parameter assessment application 240 may receive seller attributes 272 and business attributes 274. Seller attributes 272 and business attributes 274 may be received as seller input and attribute assessment test score at 241 by parameter assessment application 240. Once seller attributes 272 and business attributes 274 are received, parameter assessment application 240 may convert seller attributes 272 and business attributes 274 to seller parameter data and business parameter data at 242. As previously discussed, information from seller input and/or attribute assessment tests may be transformed to a common language of parameters. This transformation may standardize seller attributes 272 and business attributes 274 to a set of common seller parameters and business parameters.

Buyer 204a, buyer 204b, and buyer 204c may collectively correspond to a set of prospective buyers looking to purchase a business and/or business opportunity. A buyer of a business may correspond to a person and/or entity (e.g. a group of individual buyers and/or a company) who wish to purchase a business/business opportunity. Exemplary buyers may correspond to a franchisee wishing to start a franchise, a small business owner or person wishing to start/purchase a small business, a group of buyers wishing to purchase franchise rights and/or a small business, or a company wishing to purchase a small business, franchise, and/or other company.

Buyer 204a, buyer 204b, and buyer 204c may have buyer attributes 276a, buyer attributes 276b, and buyer attributes 276c, respectively. Similar to above, buyer attributes 276a-c may correspond to a set of characteristics, factors, or traits of buyers 204a-c, respectively, possessed by buyers 204a-c. Additionally, buyer attributes 276a-c may further include buyer interests related to the business, such as industry type, location, etc., as well as information about the buyer, such as buyer location, licensing, experience, etc.

Business sale listing server 230 executing parameter assessment application 240 may receive buyer attributes 276a-c. Buyer attributes 276a-c may be received as buyer input and attribute assessment test score at 243 by parameter assessment application 240. Once buyer attributes 276a-c are received, parameter assessment application 240 may convert buyer attributes 276a-c to buyer parameter data at 244. As previously discussed, information from buyer input and/or attribute assessment tests may be transformed to a common language of parameters. This transformation may standardize buyer attributes 276a-c to a set of common buyer parameters.

In addition to the business parameters converted from business attributes 274, additional business parameters known about the business, the business type, and/or the business industry (e.g. required licensing, experience, etc.) may be retrieved at 245. Once buyer parameters are collected at 244, and seller parameters and buyer parameters at 245, the parameters may be normalized and compared at 246. Normalization of the factors may adjust the factors to a common scale, where the common scale may also account for user adjusted importance of individual parameters. For example, normalization may first adjust seller parameters, business parameters, and buyer parameters to a common scale or point system, where seller 202 and/or buyers 204a-c may adjust the importance or percentage weight of each parameter in the scale/point system.

Comparison of the factors at 246 may include determining an interim score for each parameter comparison. For example, a seller parameter corresponding to a first behavioral style and a buyer parameter corresponding to a second behavioral style may be compared to determine an interim score of that comparison. The interim score may be based on a likelihood of those parameters “matching” or working together as a good fit. Scores can be determined and adjusted as described in reference to FIG. 1.

Once interim scores have been determined for each buyer parameter to seller and business parameter, a total score for the comparison(s) may be determined and a list of likely matches created at 247. The total score may assist seller 202 and buyers 204a-c in determining if a sale of business 206 would be likely and/or desirable. The list may be viewed by seller 202 so that seller 202 may see matching prospective buyers. Additionally, if one or more of buyers 204a-c is determined to be a match to business 206, seller 202 and business 206 may be displayed to the one or more of buyers 204a-c.

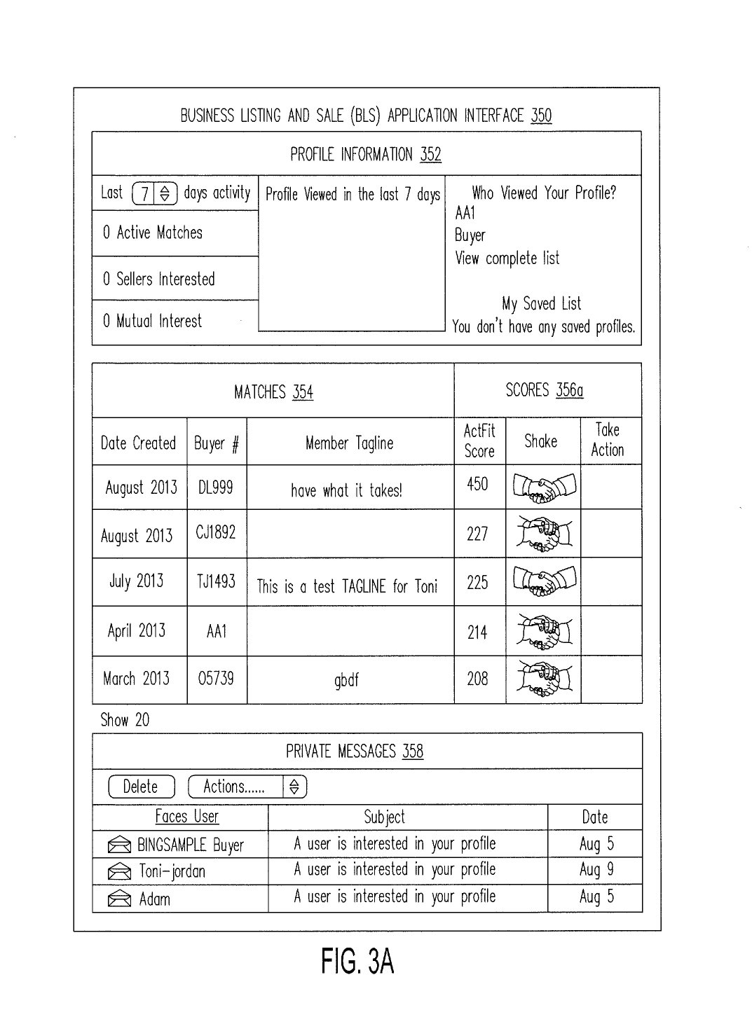

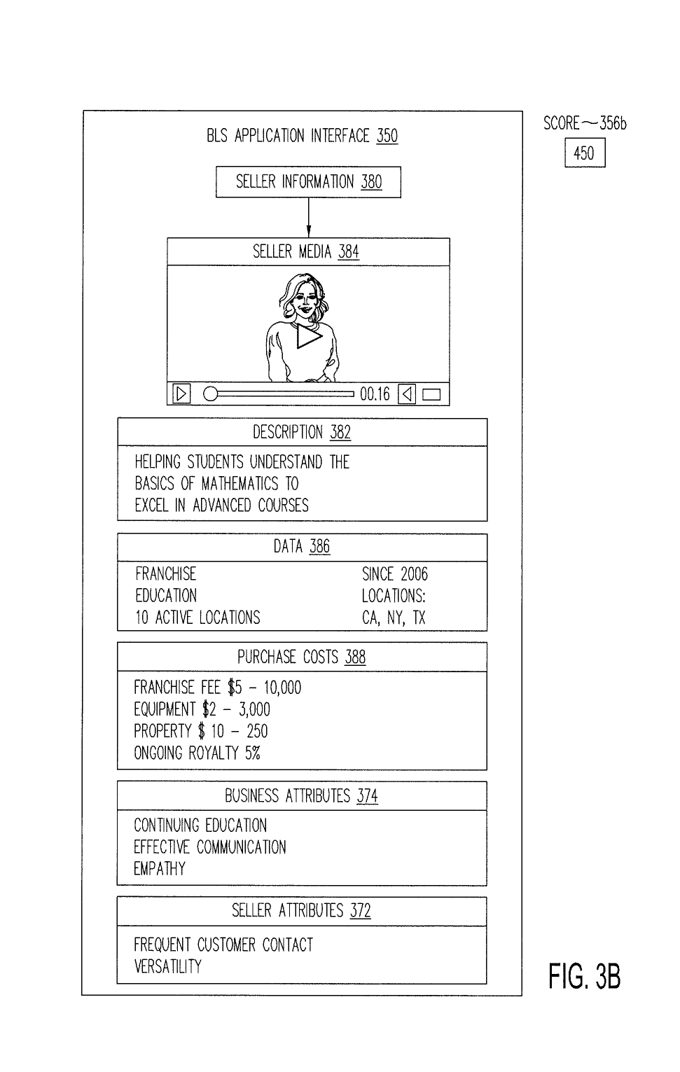

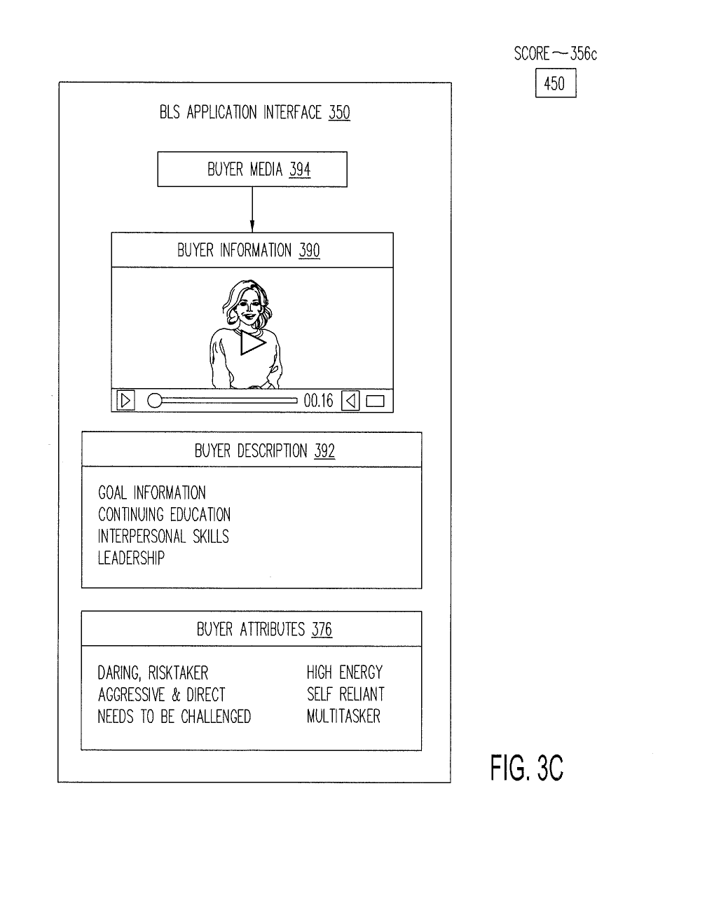

FIG. 3A is an exemplary display interface for a business listing and sale application, according to an embodiment. FIG. 3A displays business listing and sale (BLS) application interface 350, which may correspond generally to business listing and sale (BLS) application 150 of FIG. 1.

FIG. 3A displays an application interface that may be viewable to either a seller of a business or a prospective buyer of a business. BLS application interface 350 displays a profile page for a buyer or seller. BLS application interface 350 includes profile information 352, which may correspond to a set of information displayable to the buyer or seller including account activity, profile views by other users, and stored lists of other user's profiles. Profile information 352 may include analytics about account activity, profile views, and/or other processed data. Profile information 352 may include further information, such as buyer/seller information which may be displayed to another user. Profile information 352 may be edited by the user.

The profile visible in BLS application interface 350 may also include matches 354. Matches 354 may correspond to different matches for a prospective buyer and a seller of a business. For example, a prospective buyer may see matching sellers/businesses in matches 354, while a seller of a business may view matching prospective buyers in matches 354. Matches may display a date of the match, an identification of a matching party (e.g. a name, identifier, or contact information), and a short message from the matching party. Included next to matches 354 is scores 356a. Scores 356a may display further information for the matching party including a score for the match likelihood between the parties. While scores 356a further displays actions to take with the matching party (e.g. establishing contact, viewing a profile, or transmitting a greeting), matches 354 may include these processes. Matches 354 and/or scores 356a may further include a process to access information, including a profile page, of the matching party.

The profile of BLS application interface 350 further includes private messages 358. Private messages 358 may correspond to personal messages between one or more users of a business sale listing server. Private messages 358 may include messages from a matching party, from another buyer/seller utilizing the business sale listing server, or from an outside party, such as an advertising agency, a business broker, and/or a franchisor/franchisee.

FIG. 3B is an exemplary profile of a seller of a business as displayed to a prospective buyer, according to an embodiment. The seller profile displayable to a prospective buyer in BLS application interface 350 includes seller information 380. Seller information 380 may include profile information for a seller and a business of the seller. Thus, information in seller information 380 may enable a prospective buyer of a business to become knowledge about the business, learn if the business would be a good fit for the buyer, and view media, business attributes/parameters, seller attributes/parameters, and/or purchase costs of the business.

Seller information 380 displays score 356b that corresponds to a score for a match likelihood between the prospective buyer viewing seller information 380 and the business displayed in FIG. 3B. Score 356b may be calculated as previously discussed. Additionally, seller information 380 includes data 382. Data 382 may include information about the business of the seller. Data 382 displays franchise information about the business and the industry of the business. Data 382 may include additional or different information as necessary in various embodiments.

Seller information 380 also includes seller media 384. Seller media 384 may correspond to videos, pictures, or other media displayable to a prospective buyer. For example, seller media 384 includes a video, which may describe the seller and/or the business, act as an advertisement, or provide additional information for a prospective buyer. Seller media may further include interactive media that a buyer may participate in to learn more about the business. Interactive media may correspond to games, questionnaires/tests, etc.

Purchase costs 388 of seller information 380 may include information about initial business price, equipment, property, or other costs of beginning and maintaining the business, as well as future prices, such as ongoing royalties, yearly fees, etc. Purchase costs may also include information related to employee costs, tax information, licensing costs, or other expected costs for purchase and operation of the business.

In addition, a prospective buyer of the business may see seller attributes 372 and business attributes 374. Seller attributes 372 and business attributes 374 may correspond to input and/or attribute assessment test results provided to a business listing server for purposes of matching prospective buyers to businesses for sale. Thus, viewing seller attributes 372 and business attributes 374 may assist a prospective buyer in deciding whether or not to purchase a business. Seller attributes 372 and business attributes 374 may include both attributes directly received by the business sale listing server and transformed seller parameters and business parameters.

FIG. 3C is an exemplary profile of a prospective buyer as displayed to a seller of a business, according to an embodiment. The buyer profile displayable to a prospective buyer in BLS application interface 350 includes buyer information 390. Buyer information 390 may include profile information for a prospective buyer. Thus, information in buyer information 390 may enable a seller of a business to become knowledge about a prospective buyer to learn whether the buyer would be a good fit for the business, is likely to purchase the business, and whether an apprenticeship period would be beneficial and reasonable.

Buyer information 390 includes buyer description 392, which may include information about the prospective buyer. Buyer description 392 may include information entered by the prospective buyer when establishing the buyer profile, including resume information, skills information, and/or financial information. Buyer description 392 may assist the seller of the business in learning about the prospective buyer as well as if a sale of the business is financial feasible for the prospective buyer.

The prospective buyer may also include buyer media 394 in buyer information 390. Buyer media 394 may include a video for display to the seller of the business. Additionally, buyer media 394 may include additional media information about the buyer including financial information (e.g. previous business/personal financial information) or interactive information. Buyer media 394 may be utilized to provide a more personalized message to sellers of businesses.

Lastly, buyer information may also include buyer attributes 376. Buyer attributes 376 may correspond to input and/or attribute assessment test results provided to a business listing server for purposes of matching prospective buyers to businesses for sale. Thus, viewing buyer attributes 376 may assist the seller of the business in deciding whether or not a purchase would be feasible and likely with the prospective buyer. Buyer attributes 376 may include both attributes directly received by the business sale listing server and transformed buyer parameters

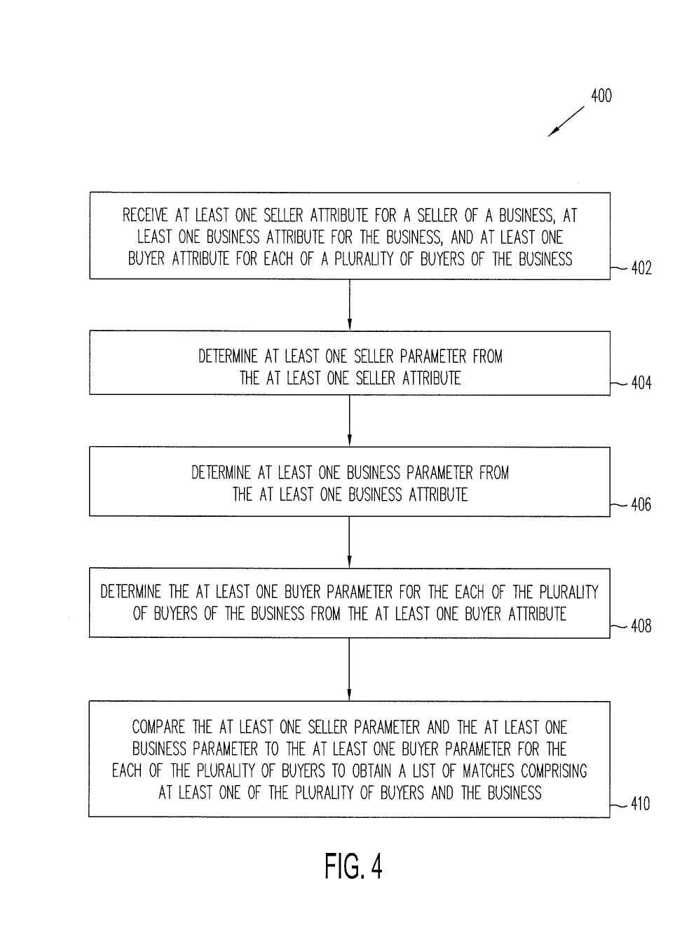

FIG. 4 is a flowchart of an exemplary process for matching buyers and sellers based on business oriented parameters, according to an embodiment. Note that one or more steps, processes, and methods described herein may be omitted, performed in a different sequence, or combined as desired or appropriate.

At step 402, at least one seller attribute for a seller of a business, at least one business attribute for the business, and at least one buyer attribute for each of a plurality of buyers of the business is received. As previously discussed, a seller of a business may correspond to sellers of small or single business or may correspond to a variety of other business sellers. For example a seller of a business may correspond to a franchisor who wishes to sell a franchise and/or franchise rights (e.g. rights to establish a franchise branch, including number of stores and/or location restrictions of the franchise branch). The seller may also correspond to a partner in a partnership, including businesses, law firms, accounting firms, etc., that may wish to seller the partnership or the partner's specific partner share. The seller may also correspond to an owner of a profit or nonprofit company. Other exemplary sellers and/or businesses may correspond to hospitals or other care facilities, charities, and/or private contracting opportunities. The aforementioned list is not exhaustive and both the seller and/or business may correspond to another type of seller offering a business opportunity for purchase. A buyer of a business may correspond to a person and/or entity (e.g. a group of individual buyers and/or a company) who wish to purchase a business/business opportunity. Exemplary buyers may correspond to a franchisee wishing to start a franchise, a small business owner or person wishing to start/purchase a small business, a group of buyers wishing to purchase franchise rights and/or a small business, or a company wishing to purchase a small business, franchise, and/or other company.

The at least one seller attribute and the at least one buyer attribute may correspond to one or more of personal skills, personal talents, attributes of the business, personal communication style, personal behavioral style, personal values corresponding to the business, personal business motivators, desired business rewards, desired business location, current personal location, personal experience in an industry of the business, and desired business industry. Additionally, the at least one business attribute may correspond to one or more of the industry of the business, a type of the business, location of the business, required business licensing, required personal licensing for operation of the business, and required personal experience in the industry of the business.

At least one seller parameter, at least one business parameter, and at least one buyer parameter for each of the plurality of buyers is determined from the at least one seller attribute, the at least one business attribute, and the at least one buyer attribute, respectively, at steps 402, 404, and 406. The at least one seller parameter may be determined using at least one of seller input and seller responses to an attribute assessment test. The at least one buyer parameter may be determined using at least one of buyer input and buyer responses to an attribute assessment test. Moreover, the least one business parameter may be determined using at least one of the buyer input and stored parameters corresponding to the business and business industry.

Each of the at least one seller parameter, the at least one business parameter, and the at least one buyer parameter may correspond to a plurality of common parameters for each of the seller, the business, and the buyer. Thus, the parameters for each of the seller, the business, and the buyer may be determined in a common set of parameters for easier comparison and scoring of the parameter comparisons.

At step 410, the at least one seller parameter and the at least one business parameter is compared to the at least one buyer parameter for the each of the plurality of buyers to obtain a list of matches comprising at least one of the plurality of buyers and the business. In addition to the comparison, a score for a match likelihood using the plurality of common parameters for each of the seller, the business, and the buyer may be determined. The score may be determined using a relative weight assigned to the at least one seller parameter, the at least one business parameter, and/or the at least one buyer parameter.

The score and the list of matches may be displayed to the seller of the business and/or the buyer of the business. The seller of the business may further receive buyer information for each of the plurality of buyers of the business. The buyer of the business may receive business/seller information for each of the businesses.

In various embodiments, an offer for a purchase of the business may be sent by the buyer to the seller. The offer may be completed with the seller if the seller agrees. However, if the seller does not agree, the seller may respond with a counteroffer. The offer may also comprise a term of apprenticeship of the buyer with the business and future terms of purchase, in certain embodiments.

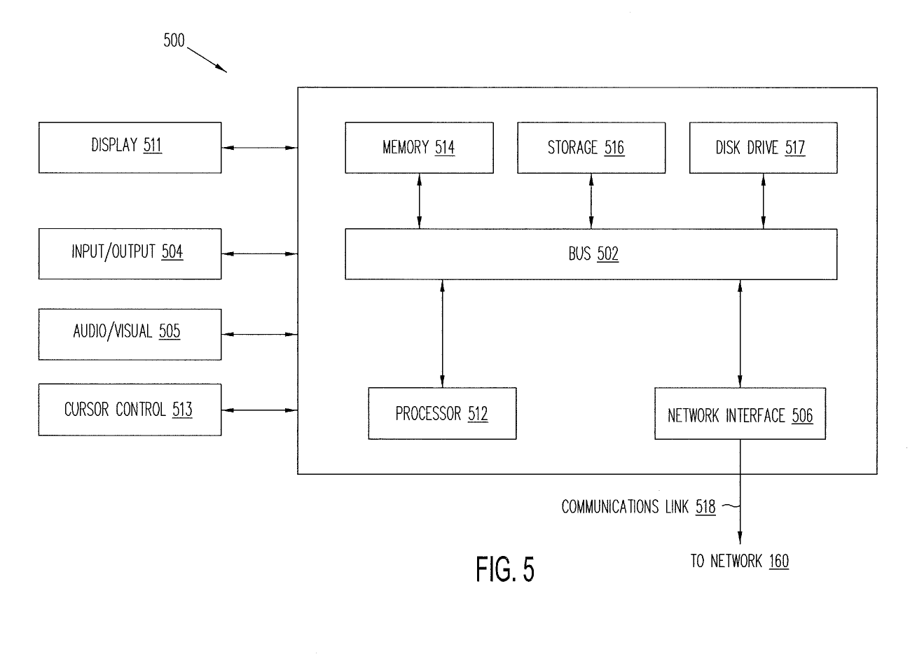

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, a merchant server, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing business parameter information comprising at least one business parameter; and
one or more hardware processors in communication with the non-transitory memory and configured to:
receive at least one seller attribute for a seller of a business, at least one business attribute for the business, and at least one buyer attribute for each of a plurality of buyers of the business;
determine at least one seller parameter from the at least one seller attribute;
determine the at least one business parameter from the at least one business attribute;
determine the at least one buyer parameter for the each of the plurality of buyers of the business from the at least one buyer attribute; and
compare the at least one seller parameter and the at least one business parameter to the at least one buyer parameter for the each of the plurality of buyers to obtain a list of matches comprising at least one of the plurality of buyers and the business.

2. The system of claim 1, wherein the at least one seller parameter is determined using at least one of seller input and seller responses to an attribute assessment test, wherein the at least one buyer parameter is determined using at least one of buyer input and buyer responses to an attribute assessment test, and the least one business parameter is determined using at least one of the seller input and stored parameters corresponding to the business and business industry.

3. The system of claim 2, wherein the at least one seller attribute and the at least one buyer attribute is one of personal skills, personal talents, attributes of the business, personal communication style, personal behavioral style, personal values corresponding to the business, personal business motivators, desired business rewards, desired business location, current personal location, personal experience in an industry of the business, and desired business industry, and wherein the at least one business attribute is one of the industry of the business, a type of the business, location of the business, required business licensing, required personal licensing for operation of the business, and required personal experience in the industry of the business.

4. The system of claim 2, wherein the at least one seller parameter, the at least one business parameter, and the at least one buyer parameter comprise a plurality of common parameters.

5. The system of claim 4, wherein the one or more hardware processors is further configured to:
determine a score for a match likelihood using the plurality of common parameters for each of the seller parameters, the business parameters, and the buyer parameters.

6. The system of claim 5, wherein the score is determined using a relative weight of each of the at least one seller parameter, the at least one business parameter, and the at least one buyer parameter.

7. The system of claim 6, wherein the one or more hardware processors is further configured to:
display the score and the list of matches with buyer information for the at least one of the plurality of buyers in the list of matches to the seller of the business; and
display the score and business information for the business to the at least one of the plurality of buyers in the list of matches.

8. The system of claim 1, wherein the one or more hardware processor is further configured to:
transmit an offer for a purchase of the business to the seller; and
complete the purchase of the business between the buyer and the seller if the seller agrees to the offer.

9. The system of claim 8, wherein the offer comprises a term of apprenticeship of the buyer and terms of future purchase of the business.

10. The system of claim 8, wherein the one or more hardware processors us further configured to;
transmit a counteroffer for the purchase of the business to the buyer if the seller does not agree to the offer.

11. A method comprising:
receiving at least one seller attribute for a seller of a business, at least one business attribute for the business, and at least one buyer attribute for each of a plurality of buyers of the business;
determining at least one seller parameter from the at least one seller attribute;
determining the at least one business parameter from the at least one business attribute;
determining at least one buyer parameter for the each of the plurality of buyers of the business from the at least one buyer attribute; and
comparing, using one or more hardware processors of a server, the at least one seller parameter and the at least one business parameter to the at least one buyer parameter for the each of the plurality of buyers to obtain a list of matches comprising at least one of the plurality of buyers and the business.

12. The method of claim 11, wherein the at least one seller parameter is determined using at least one of seller input and seller responses to an attribute assessment test, wherein the at least one buyer parameter is determined using at least one of buyer input and buyer responses to an attribute assessment test, and the least one business parameter is determined using at least one of the seller input and stored parameters corresponding to the business and business industry.

13. The method of claim 12, wherein the at least one seller parameter, the at least one business parameter, and the at least one buyer parameter comprise a plurality of common parameters for each of the seller, the business, and the buyer.

14. The method of claim 13 further comprising:
determining a score for a match likelihood using the plurality of common parameters for each of the seller parameters, the business parameters, and the buyer parameters.

15. The method of claim 14, wherein the score is determined using a relative weight of each of the at least one seller parameter, the at least one business parameter, and the at least one buyer parameter.

16. The method of claim 15 further comprising:
displaying the score and the list of matches with buyer information for the at least one of the plurality of buyers in the list of matches to the seller of the business; and
displaying the score and business information for the business to the at least one of the plurality of buyers in the list of matches.

17. The method of claim 11 further comprising:
transmitting an offer for a purchase of the business to the seller; and
completing the purchase of the business between the buyer and the seller if the seller agrees to the offer.

18. The method of claim 17, wherein the offer comprises a term of apprenticeship of the buyer and terms of future purchase of the business.

19. The method of claim 17 further comprising:
transmitting a counteroffer for the purchase of the business to the buyer if the seller does not agree to the offer.

20. A non-transitory computer readable medium comprising a plurality of machine-readable instructions which when executed by one or more processors of a server are adapted to cause the server to perform a method comprising:
receiving at least one seller attribute for a seller of a business, at least one business attribute for the business, and at least one buyer attribute for each of a plurality of buyers of the business;
determining at least one seller parameter from the at least one seller attribute;
determining the at least one business parameter from the at least one business attribute;
determining at least one buyer parameter for the each of the plurality of buyers of the business from the at least one buyer attribute; and
comparing the at least one seller parameter and the at least one business parameter to the at least one buyer parameter for the each of the plurality of buyers to obtain a list of matches comprising at least one of the plurality of buyers and the business.
